(19) United States
(12) Patent Application Publication
(10) Pub. No.: US 2001/0044232 A1
(43) Pub. Date: Nov. 22, 2001

(54) CONNECTOR FOR HIGH-FREQUENCY DATA TRANSMISSION VIA ELECTRICAL LINES

(76) Inventor: HANS REICHLE, WETZIKON (CH)

Correspondence Address: VENABLE BAETJER HOWARD & CIVILETTI LLP, PO BOX 34385, WASHINGTON, DC, 200439998

(21) Appl. No.: 09/409,983

(22) Filed: Sep. 30, 1999

(30) Foreign Application Priority Data
Sep. 30, 1998 (CH) 1989/98

(51) Int. Cl. H01R 4/24

(52) U.S. Cl. 439/418

(57) ABSTRACT

With connectors of a plug connection for high-frequency data transmission via several twisted electrical conductor pairs in a cable, the conductors at the cable end are separated by undoing the twist and then connected via wire connection means to contacts. The individual conductors of the conductor pairs directly at the cable exit are in a set sequence and are guided parallel in two planes at a set distance from each other in a contact housing (11) of non-conducting material that can be installed in the contact plug, and they are preferably connected there to the relevant contacts (1′-8′) via an insulation displacing connecting device (9′) in an IDC contact element (9).

These measures optimally reduce electric (capacitive) and magnetic (inductive) cross-talk coupling in the high-frequency plugs. In particular, cross-talk suppression is attained by a very short length of untwisted conductor pairs, by parallel individual conductors in two planes that follow a very short path without crossing, by a large distance between conductors, and by avoiding piercing contacts that act as capacitors. In addition, the arrangement allows easy, mechanical connection of the individual conductors and easy installation in standard RJ 45 high-frequency connectors.

The present invention concerns a connector, especially a contact plug of a plug connection for high-frequency data transmission via several twisted electrical conductor pairs in a cable, and the conductors at the cable end are separated by undoing the twist and then connected via wire connection means to contacts to be releasably connected to corresponding contacts of the mating component of the plug connection.

In telecommunications and high-frequency data transmission via electrical conductors, modular plug connection systems such as RJ 45 (8-pin) or RJ 11 (6-pin) are common with a set contact point assignment, e.g. with an assignment of terminals 4 and 5 or 1 and 2 for the receiver loop and connectors 3 and 6 for the transmitter loop.

With RJ 45 plug connection systems, it is required to separate the terminals for the conductor pair 3/6 at the interface and place the terminal of conductor 3 between the terminals of pair 1/2 and 4/5 and terminal of conductor 6 between the terminals 4/5 and 7/8.

The quality of such plug connection systems particularly depends on cross-talk attenuation since cross-talk arises between the conductors. For example, a certain output is overcoupled from the disturbing conductor to the disturbed conductor, and the measure for this is cross-talk attenuation in decibels. The lower the cross-talk attenuation, the greater the overcoupled noise. Targeted cross-talk compensation can reduce or compensate for this noise whereby a targeted overcoupling of an additional, equivalent, yet antiphase output is sought.

There hence exist various prior art measures to suitably improve the cross-talk attenuation of such plug connection systems with a set contact assignment in the connector elements. This has only been able to be realized to date with the connecting sockets of the plug connection systems. An attempt was made to compensate the poor HF properties of the plugs of such plug connection systems, but this was only limitedly effective with a great deal of effort. In addition, the prior art plugs are difficult to wire manually given the required transposition of the conductors. The used flat piercing contacts impaired the HF properties due to the capacitor effect in addition to the difficult contacting of the conductors.

The problem of the present invention is therefore to create a connector, especially a high-frequency connector of for cited plug connection systems in which both electrical (capacitive) and magnetic (inductive) cross-talk coupling is reduced as much as possible to enable cross-talk suppression greater than 200 MHz and possibly eliminate special compensation measures in the sockets. In addition, the design is such that the individual conductors can be easily connected mechanically with the terminals, and the unit is suitable to be incorporated in a standard size conventional high-frequency plug.

This is accomplished according to the invention by taking the individual conductors of the conductor pair directly at the cable exit and guiding them parallel in a set sequence in two planes at a set distance in a contact housing of non-conducting material that can be installed in the contact plug. The conductors are preferably connected there to the relevant contacts via an insulation displacing connecting device in an IDC contact element.

It is advantageous when the individual conductors can be inserted in the contact housing and extend insulated between the ribs of the contact housing, and when the contacts of the IDC contact elements are in a row, and are on free ends of correspondingly bent contact arms that extend from the insulation displacing connecting devices (IDCDs). Between the contacts and their IDCDs is the smallest possible distance in the lengthwise direction of the conductor. It is also advantageous when the IDC contact elements are essentially rigid.

To connect conductors close to the edge, the relevant IDC contact elements can be bent outward to the side. In addition, certain contact arms can overlap to yield an alternating arrangement of conductor pairs in reference to the contacts of the IDC contact elements.

Depending on the system, the conductor pairs can be arranged as desired so that the conductors 2, 3, 6, and 7 extend in a first plane, and conductors 1, 4, 5, 8 of conductor pairs extend in a second plane, or the conductors 5, 4, 3 and 6 extend in one plane and conductors 8, 7, 2, 1 of the conductor pairs extend in a second plane.

These measures optimally reduce electric (capacitive) and magnetic (inductive) cross-talk coupling in the high-frequency plugs. In particular, cross-talk suppression is attained by a very short length of untwisted conductor pairs, by parallel individual conductors in two planes over a very short path without transposition, a large distance between conductors, and by avoiding piercing contacts that act as capacitors. In addition, the arrangement according to the invention allows the individual conductors to be easily mechanically connected and incorporated in a standard RJ 45 high-frequency connector.

Such connectors can be used for sockets without special compensatory measures.

Exemplary embodiments of the subject of the invention are further explained in the following with reference to drawings. Shown are:

FIG. 1 An exploded view of a RJ 45 high-frequency connector with the design according to the invention,

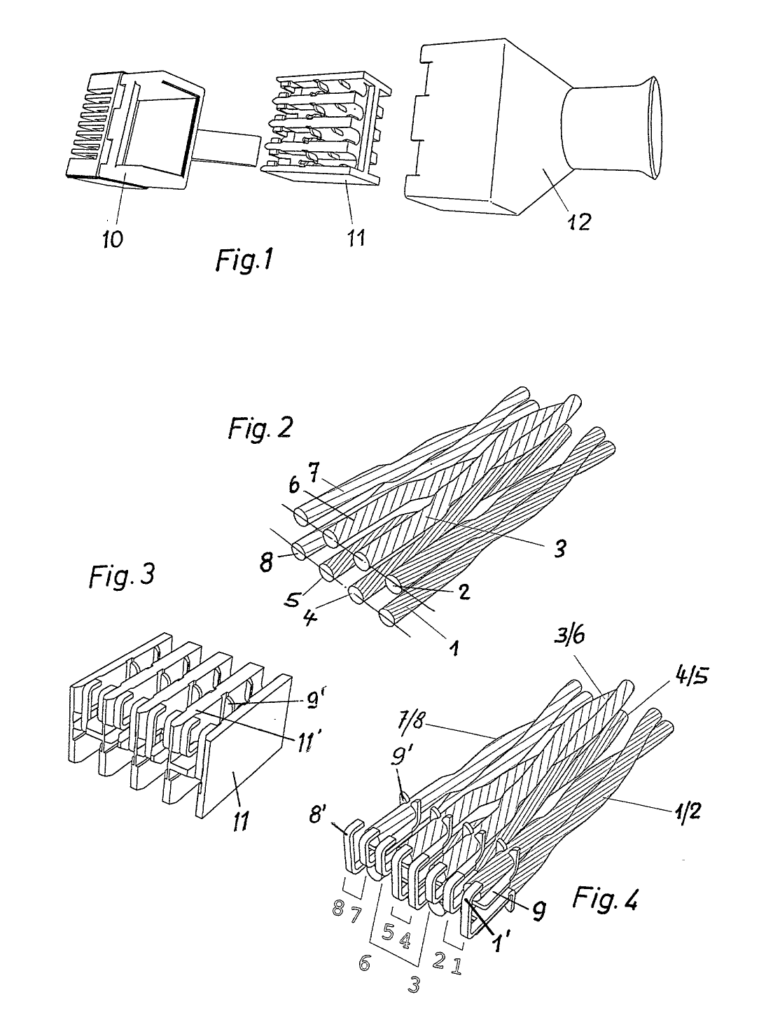

FIG. 2 A schematic illustration of untwisted conductor pairs according to the invention with parallel conductors in two planes,

FIG. 3 Enlarged illustration of a contact housing for the contact set from FIG. 4,

FIG. 4 Enlarged illustration of a contact set according to the invention to be installed in RJ 45 high-frequency connectors,

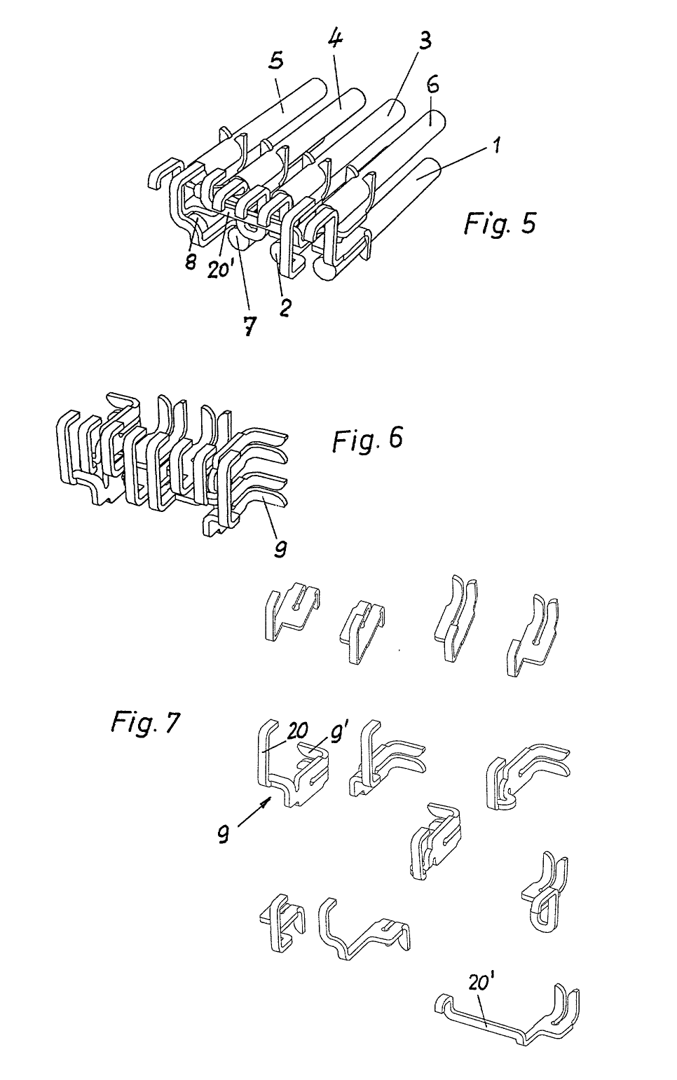

FIG. 5 and 6 Enlarged illustration of various embodiments of contact sets according to the invention to be installed in RJ 45 high-frequency connectors, and

FIG. 7 Different scale and embodiments of angled IDC contact elements with an extending contact arm for a contact set according to FIG. 4, 5 and 6.

An exemplary RJ 45 high-frequency connector from FIG. 1 comprises a connector housing 10, a contact housing 11 that can be inserted in it, and a screen 12. With such a contact plug of a plug connection for high-frequency data transmission via several twisted electrical conductor pairs of a cable, the conductors at the cable end are separated by being untwisted, and they are connected to contacts via wire connection means to provide a releasable connection with corresponding contacts of the mating component of the plug connection (not shown).

According to the invention, the individual conductors of the conductor pairs 1/2, 3/6, 5/4, 7/8 directly at the cable exit are in a set sequence and are guided parallel in two planes at a set distance from each other in the cited contact housing 11 of non-conducting material that can be installed in the contact plug, and they are connected there to the relevant contacts 1′-8′ via an insulation displacing connecting device 9′ in an IDC contact element 9, as shown in detail in FIG. 2, 3 and 4.

By using the contact housing 11, the individual conductors can be inserted in the contact housing e.g. mechanically where they can extend insulated between the ribs 11′ of the contact housing. Since the inserted IDC contact elements 9 in this housing are in a set arrangement, they can be connected by inserting the conductors.

The contacts 1′-8′ of the IDC contact elements 9 (FIG. 4) form a row and are located at the free end of the correspondingly bent contact arms 20 that extend from the IDCDs 9′. There is a very short distance between the contacts and their IDCDs following the length of the conductor.

These IDC contact elements 9 are essentially rigid.

With the arrangement according to the invention in FIG. 2, 3 and 4, conductors 2, 3, 6, and 7 of conductor pairs 1/2, 3/6, 5/4, 7/8 extend in a first plane, and conductors 1, 4, 5, 8 extend in a second plane.

Depending on the system, conductors 5, 4, 3, and 6 of conductor pairs 1/2, 3/6, 5/4, 7/8 can extend in a first plane, and conductors 8, 7, 2, and 1 can extend in a second plane as illustrated in FIG. 5. Predetermined contact arms 20′ correspondingly overlap for the alternating arrangement of the conductor pair in reference to the contacts of the IDC contact elements 9.

In other embodiments, the relevant IDC contact elements 9 can be bent outward to the side to connect conductors close to the edge as in FIG. 6.

A number of possible embodiments of IDC contact elements 9 are in FIG. 7 for the contact sets in FIG. 4, 5 and 6.

From the above, a connector results (especially a high-frequency connector) where both electrical (capacitive) and magnetic (inductive) cross-talk coupling is optimally reduced.

In particular, the cross-talk is suppressed by a very short path of untwisted conductor pairs, by parallel individual lines that traverse a very short path without crossing in two planes to produce a large conductor spacing, and by avoiding piercing contacts that act as capacitors. In addition, the arrangement according to the invention allows the individual conductors to be mechanically connected and easily installed in a standard RJ 45 high-frequency connector, etc.

Such connectors are compatible with different systems, and they can be used for sockets without special measures for cross-talk suppression.

Of course, other various embodiments are conceivable without departing from the inventive idea. In particular, other connection means are possible instead of the preferred IDC wire connection means.

The following are claimed:

1. A connector, especially a contact plug of a plug connection for high-frequency data transmission via several twisted electrical conductor pairs in a cable, and the conductors at the cable end are separated by undoing the twist and then connected via wire connection means to contacts to be releasably connected to corresponding contacts of the mating component of the plug connection, characterized in that the individual conductors of the conductor pair right at the cable exit are guided parallel in a set sequence in two planes at a set distance in a contact housing (11) of non-conducting material that can be installed in the contact plug, and they are preferably connected to the relevant contacts (1′-8′) via an insulation displacing connecting device (9′) in an IDC contact element (9).

2. The connector according to claim 1, characterized in that the separated conductors are inserted in the contact housing (11) and extend insulated between ribs (11′) of the contact housing.

3. The connector according to claim 1, characterized in that the contacts (1′-8′) of the IDC contact elements (9) form a row and are located at the free end of the correspondingly bent contact arms (20) that extend from the IDCDs, (9′) whereby there is a very short distance following the length of the conductor between the contacts and their IDCDs (FIG. 4-6).

4. The connector according to claim 1, characterized in that the IDC contact elements (9) are essentially rigid.

5. The connector according to claims 1-4, characterized in that the relevant IDC contact elements (9) can be bent outward to the side to connect conductors close to the edge (FIG. 6).

6. The connector according to claims 1-4, characterized in that the given contact arms (20′) correspondingly overlap (FIG. 5) for an alternating arrangement of conductor pairs in reference to the IDC contact elements (9).

7. The connector according to claim 1, characterized in that conductors 2, 3, 6, and 7 of conductor pairs (1/2, 3/6, 5/4, 7/8) extend in a first plane, and conductors 1, 4, 5, 8 extend in a second plane (FIG. 2).

8. The connector according to claim 1, characterized in that the conductors 5, 4, 3, and 6 of conductor pairs (1/2, 3/6, 5/4, 7/8) extend in a first plane, and conductors 8, 7, 2, and 1 extend in a second plane (FIG. 5).
